(19) United States
(12) Patent Application Publication
(10) Pub. No.: US 2006/0232737 A1
(43) Pub. Date: Oct. 19, 2006

(54) Liquid crystal display panel and liquid crystal display

(75) Inventors: Tze Min Lin, Miao-Li (TW); Chueh Ju Chen, Miao-Li (TW); Chiu Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/404,396

(22) Filed: Apr. 14, 2006

(30) Foreign Application Priority Data
Apr. 15, 2005 (TW) 94205940

(51) Int. Cl. G02F 1/1343

(52) U.S. Cl. 349/141

(57) ABSTRACT

A liquid crystal display (4) includes a plurality of gate lines (413) and data lines (415) formed on a substrate, thereby defining a plurality of pixel regions. Each pixel region has a pixel electrode assembly (431), a common electrode assembly (433) spaced apart from the pixel electrode assembly and a plurality of transistor (420). The pixel electrode assembly has a pixel line (431b) and at least one pixel electrode (431a), one of the at least one pixel electrode defining an acute angle junction region where said one of the at least one pixel electrode adjoins the pixel line. The common electrode assembly has a common line (433b) and at least one common electrode (433a). Each transistor is positioned at the acute angle junction region.

### FIELD OF THE INVENTION

The present invention relates to liquid crystal panels and liquid crystal displays (LCDs), and more particularly to an LCD panel and an LCD with a high aperture ratio.

### BACKGROUND

Recently, LCDs that are light and thin and have low power consumption characteristics have been widely used in office automation equipment, video units and the like. Such kinds of LCDs typically include a twisted nematic (TN) mode LCD and a super twisted nematic (STN) mode LCD. Although TN-LCDs and STN-LCDs have been put to practical use in many applications, they generally have a very narrow viewing angle. In order to solve the problem of narrow viewing angle, In Plane Switching (IPS) LCDs have been developed.

A typical IPS LCD includes a plurality of pixel regions defined by a plurality of data lines and gate lines perpendicular to each other. FIG. 5 illustrates one pixel region of a conventional IPS LCD 1. The pixel region includes a gate line 113, a data line 115 and a common bus line 135 both substantially orthogonal to the gate line 113, a thin film transistor (TFT) 120, and a pixel electrode assembly 131 and a common electrode assembly 133. The pixel electrode assembly 131 and the common electrode assembly 133 are each generally comb-shaped. The common electrode assembly 133 includes a straight common line 133b and a plurality of gently zigzagged common electrodes 133a. The pixel electrode assembly 131 includes a straight pixel line 131b and a plurality of gently zigzagged pixel electrodes 131a. Referring also to FIG. 6, the pixel line 131b and the zigzagged pixel electrode 131a define an acute angle α1 at one side where they adjoin each other, and also define an obtuse angle β1 at another side where they adjoin each other. The acute angle α1 and the obtuse angle β1 are supplementary angles. The acute angle α1 defines an acute angle junction region (not labeled) thereat, and the obtuse angle β1 defines an obtuse angle junction region (not labeled) thereat. The TFT 120 is positioned at an intersection of the data line 115 and the gate line 113, corresponding to the obtuse angle junction region adjacent to the pixel line 131b and one of the zigzagged pixel electrodes 131a. The TFT 120 has a gate electrode (not labeled), a source electrode (not labeled), and a drain electrode (not labeled), which are connected with the gate line 113, the data line 115, and the pixel electrode assembly 131 respectively.

When a voltage is applied, a parallel main electric field 190 between the pixel and common electrode 131a, 133a is generated. However, at junctions of the zigzagged pixel electrodes 131a and the pixel lines 131b, the electric field is abnormal, and the liquid crystal molecules thereat cannot be driven properly. Distorted electrical field corresponding to the acute angle junction region and an obtuse angle junction region are produced. As shown in FIG. 6, because the pixel electrode assembly 131 and the common electrode assembly 133 are spaced from each other, the distorted electric fields 190a, 190b at the junctions of the zigzagged pixel electrode 131a and the pixel line 131b have a plurality of directions, which directions are substantially different from directions of the main electric field 190. Thus, the liquid crystal molecules 130a in the main electrical field 190 have respective orientation, which directions are substantially different from orientation of the liquid crystal molecules 130b adjacent to the pixel line 131b and the zigzagged pixel electrode 131a.

Because the acute angle junction region has a smaller space than that of the obtuse angle junction region, the distorted electrical field 190a in the acute angle junction region has a sharper change of electrical field over a given distance than the distorted electrical filed 190b in the obtuse angle junction region. Thus, the transmission ratio of the obtuse angle junction region is higher than that of the acute angle junction region. However, the TFT 120 positioned at the obtuse angle junction region is opaque. That is, the TFT 120 blocks light beams that would otherwise be transmitted through a part of the obtuse angle junction region. This means that the TFT 120 further reduces the transmission ratio of the obtuse angle junction region. As a result, black regions corresponding to the obtuse angle junction region and the acute angle junction region are produced in a display of the IPS LCD 1.

What is needed, therefore, is a liquid crystal display panel which has an equally good visual performance at various different viewing angles and a high contrast ratio.

### SUMMARY

In a preferred embodiment, a liquid crystal display includes: a first substrate; a second substrate opposite to the first substrate; a plurality of liquid crystal molecules interposed between the first and second substrates; and a plurality of gate lines and data lines formed on the first substrate, thereby defining a plurality of pixel regions. Each pixel region has a pixel electrode assembly, a common electrode assembly spaced apart from the pixel electrode assembly and a plurality of transistor. The pixel electrode assembly has a pixel line and at least one pixel electrode, one of the at least one pixel electrode defining an acute angle junction region where said one of the at least one pixel electrode adjoins the pixel line. The common electrode assembly has a common line and at least one common electrode. Each transistor is positioned at the acute angle junction region.

In another preferred embodiment, a panel includes a substrate defining a plurality of pixel regions. Each pixel region has a pixel electrode assembly and a plurality of transistor. The pixel electrode assembly includes a pixel line, at least one pixel electrode. One of the at least one pixel electrode defines an acute angle junction region where the pixel electrode adjoins the pixel line. Each transistor is positioned at the acute angle junction region.

In still another preferred embodiment, a liquid crystal display includes: a first substrate; a second substrate opposite to the first substrate; a plurality of liquid crystal molecules interposed between the first and second substrates; and a plurality of gate lines and data lines formed on the first substrate, thereby defining a plurality of pixel regions. Each pixel region has a pixel electrode assembly, a common electrode assembly spaced apart from the pixel electrode assembly and a plurality of transistor. The pixel electrode assembly has a pixel line and at least one pixel electrode, one of the at least one pixel electrode defining a lower light transmission region and a higher light transmission region at two sides of each pixel electrode where said one of the at least one pixel electrode adjoins the pixel line. The common electrode assembly has a common line and at least one common electrode. Each transistor is positioned at an intersection of the data line and the gate line, corresponding to one lower transmission region.

Other advantages and novel features will become more apparent from the following detailed description when taken in conjunction with the accompanying drawings, in which:

### BRIEF DESCRIPTION OF THE DRAWINGS

FIG. 1 is a schematic, cross-sectional, top plan view of a pixel region of an LCD according to a first preferred embodiment of the present invention;

FIG. 2 is an enlarged view of a circled portion II of FIG. 1, showing approximate orientations of liquid crystal molecules near a junction of a pixel line and a pixel electrode;

FIG. 3 is a schematic, cross-sectional, top plan view of a pixel region of an LCD according to a second preferred embodiment of the present invention;

FIG. 4 is a schematic, cross-sectional, top plan view of a pixel region of an LCD according to a third preferred embodiment of the present invention;

FIG. 5 is a schematic, cross-sectional, top plan view of a pixel region of a conventional LCD; and

FIG. 6 is an enlarged view of a circled portion VI of FIG. 5, showing approximate orientations of liquid crystal molecules near a junction of a pixel line and a pixel electrode.

### DETAILED DESCRIPTION OF PREFERRED EMBODIMENTS

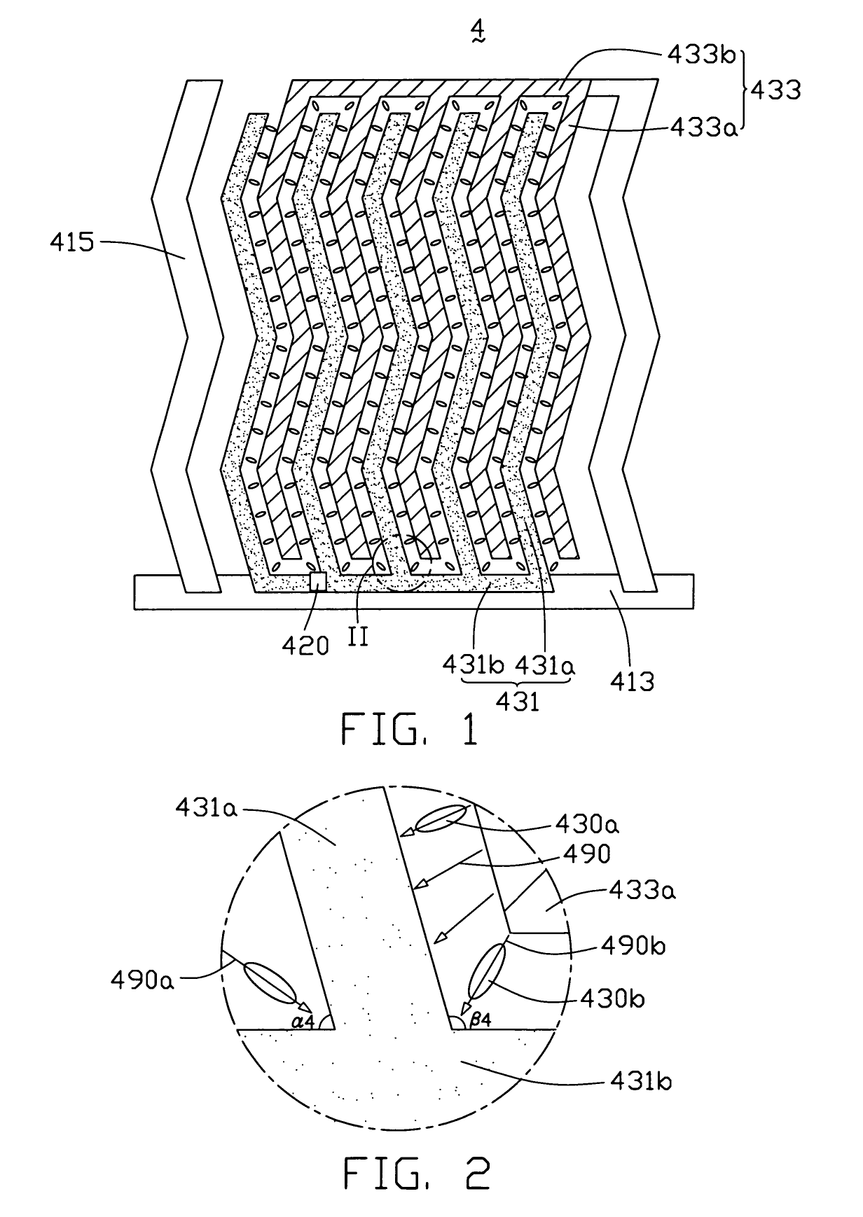

Referring to FIG. 1, an LCD 4 according to a first preferred embodiment of the present invention includes a first substrate (not shown), a second substrate (not shown) opposite to the first substrate, and a plurality of liquid crystal molecules interposed between the first and second substrates. As shown in FIG. 1, the LCD 4 further includes a plurality of gate lines 413 and a plurality of data lines 415 formed on the first substrate, thereby defining a plurality of pixel regions. Each pixel region includes a TFT 420, a pixel electrode assembly 431, and a common electrode assembly 433.

The pixel electrode assembly 431 and the common electrode assembly 433 are each generally comb-shaped. That is, each of the pixel electrode assembly 431 and the common electrode assembly 433 has gently zigzagged-shaped tooth portions, which are uniformly spaced apart from each other. In particular, the common electrode assembly 433 includes a common line 433b, and a plurality of gently zigzagged common electrodes 433a. The pixel electrode assembly 431 includes a pixel line 431b, and a plurality of gently zigzagged pixel electrodes 431a. First ends of the zigzagged pixel electrodes 431a integrally connect with the pixel line 431b respectively. Each zigzagged pixel electrode 431a defines an acute angle α4 and an obtuse angle β4 at two respective sides thereof where it adjoins the pixel line 431b. The acute angle α4 angle and the obtuse angle β4 are supplementary angles. The acute angle α4 defines an acute angle junction region (not labeled) thereat, and the obtuse angle β4 defines an obtuse angle junction region (not labeled) thereat.

The TFT 420 is positioned at an intersection of the pixel line 431b and one pixel electrode 431a, corresponding to one acute angle junction region α4. The TFT 420 has a gate electrode (not labeled), a source electrode (not labeled), and a drain electrode (not labeled), which are connected to the gate line 413, the data line 415, and the pixel electrode assembly 431 respectively. Specially, the TFT 420 is positioned adjacent to an intersection of the gate line 413 and the data line 415.

The zigzagged pixel electrodes 431a of the pixel electrode assembly 431 and the zigzagged common electrodes 433a of the common electrode assembly 433 are arranged one next to the other in alternating fashion, parallel to each other and uniformly spaced apart. Therefore when a voltage is applied at the pixel region, a parallel main electrical field 490 between the zigzagged pixel electrodes 431a and the zigzagged common electrodes 433a is produced. At the same time, a distorted electrical field 490a at the acute angle junction region and a distorted electrical field 490b at the obtuse angle junction region are also respectively produced. Thus, a plurality of liquid crystal molecules 430b in the distorted electrical fields 490a, 490b have a different orientation from that of a plurality of liquid crystal molecules 430a in the main electrical field 490. Because the distorted electrical field 490a at the acute angle junction region has a sharper change over a given distance than that of the obtuse angle junction region, fewer light beams transmit through the acute angle junction region than through the obtuse angle junction region. That is, the obtuse angle junction region has a higher transmission ratio than that of the acute angle junction region.

The LCD 4 according to the first preferred embodiment utilizes the TFT 420 positioned at the acute angle junction region having a lower transmission ratio to efficiently use the region with a lower transmission ratio and save the region with a higher transmission ratio. Therefore, the LCD 4 increase the transmission ratio and the aperture ratio of the pixel region.

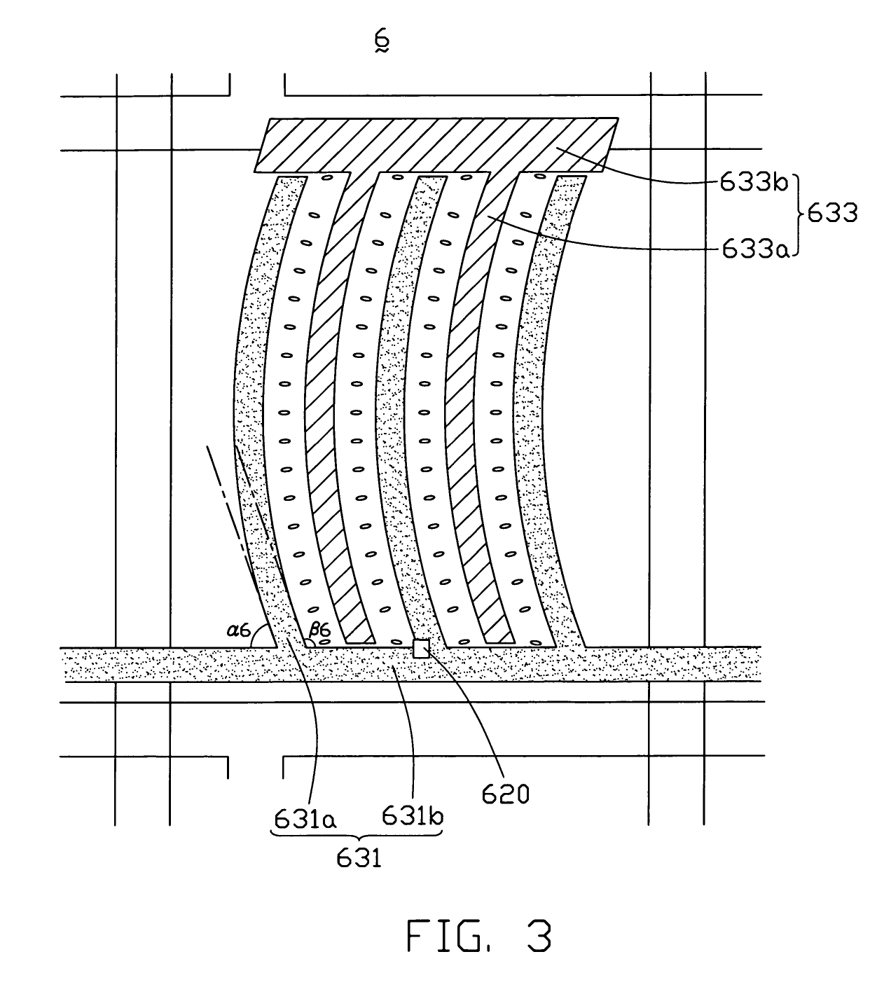

Referring to FIG. 3, an LCD 6 according to a second preferred embodiment of the present invention is shown. The LCD 6 is similar to the LCD 4 of the first preferred embodiment. However, each pixel of the LCD 6 includes a TFT 620, a pixel electrode assembly 631, and a common electrode assembly 633. The pixel electrode assembly 631 and the common electrode assembly 633 are each generally comb-shaped. That is, each of the pixel electrode assembly 631 and the common electrode assembly 633 has gently curved tooth portions, which are uniformly spaced apart from each other. In particular, the common electrode assembly 633 includes a common line 633b, and a plurality of arcuate common electrodes 633a. The pixel electrode assembly 631 includes a pixel line 631b, and a plurality of arcuate pixel electrodes 631a. Each arcuate pixel electrode 631a defines an acute angle α6 and an obtuse angle β6 at two respective sides thereof where it adjoins the pixel line 631b. The acute angle α6 and the obtuse angle β6 are supplementary angles. The acute angle α6 defines an acute angle junction region (not labeled) thereat, and the obtuse angle β6 defines an obtuse angle junction region (not labeled) thereat. The TFT 620 is positioned at the acute angle junction region.

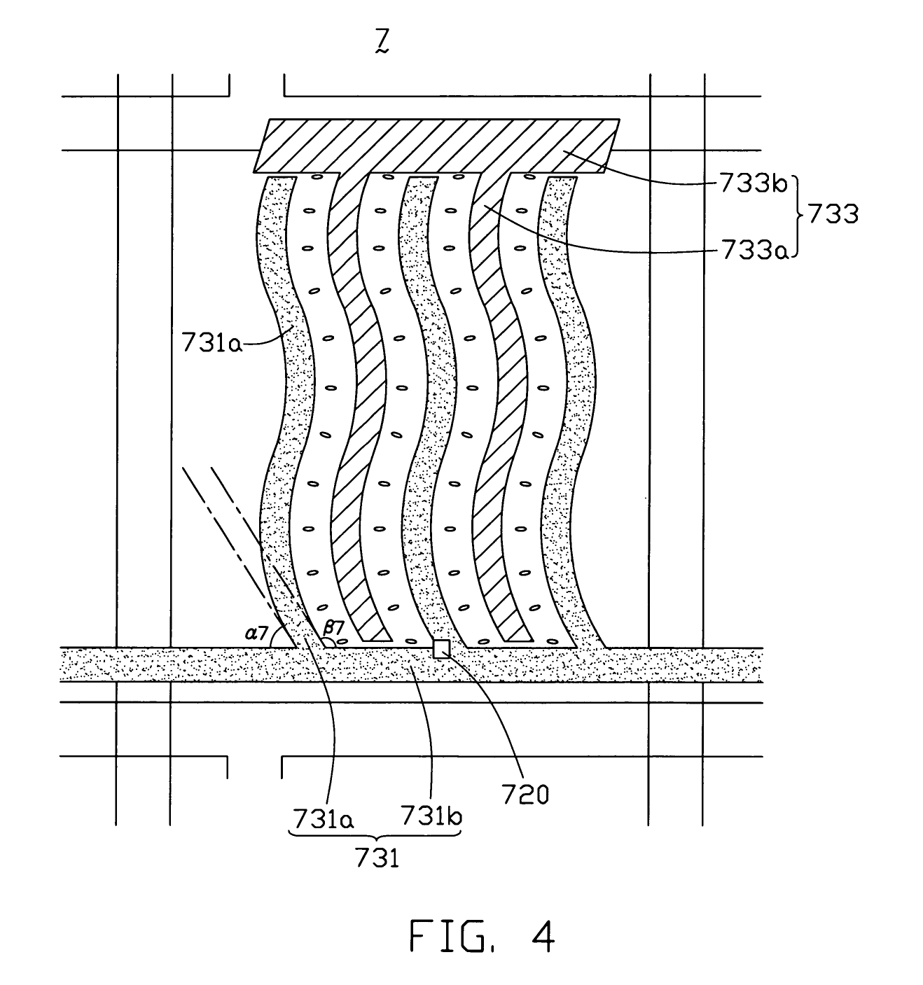

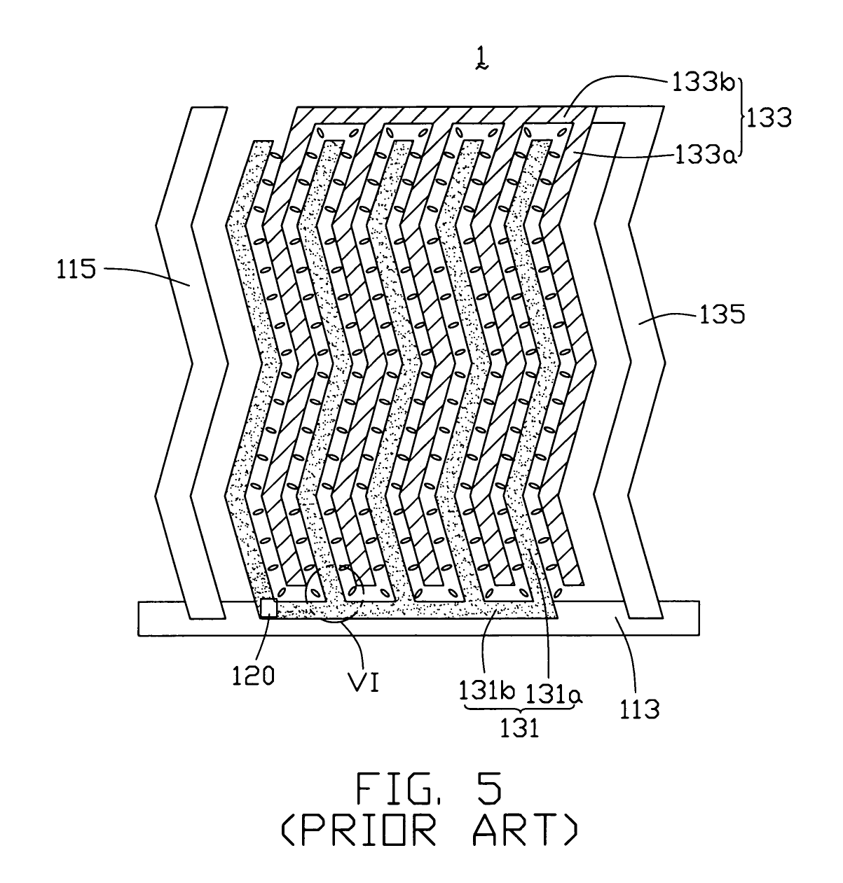

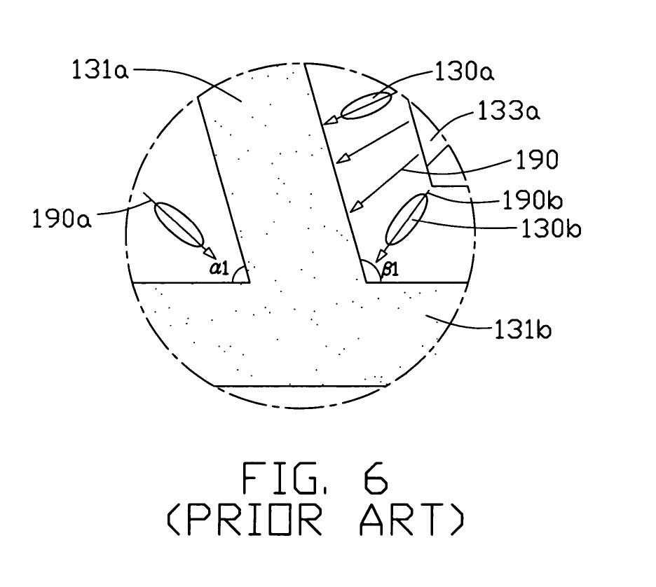

Referring to FIG. 4, an LCD 7 according to a third preferred embodiment of the present invention is shown. The LCD 7 is similar to the LCD 4 of the first preferred embodiment. However, each pixel of the LCD 7 includes a TFT 720, a pixel electrode assembly 731, and a common electrode assembly 733. The pixel electrode assembly 731 and the common electrode assembly 733 are each generally comb-shaped. That is, each of the pixel electrode assembly 731 and the common electrode assembly 733 has gently wavy tooth portions, which are uniformly spaced apart from each other. In particular, the common electrode assembly 733 includes a common line 733b, and a plurality of undulate common electrodes 733a. The pixel electrode assembly 731 includes a pixel line 731b, and a plurality of undulate pixel electrodes 731a. Each undulate pixel electrode 731a defines an acute angle α7 and an obtuse angle β7 at two respective sides thereof where it adjoins the pixel line 731b. The acute angle α7 and the obtuse angle β7 are supplementary angles. The acute angle α7 defines an acute angle junction region (not labeled) thereat, and the obtuse angle β7 defines an obtuse angle junction region (not labeled) thereat. The TFT 720 is positioned at the acute angle junction region.

It is to be understood, however, that even though numerous characteristics and advantages of various embodiments of the present invention have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A liquid crystal display, comprising:
a first substrate;
a second substrate opposite to the first substrate;
a plurality of liquid crystal molecules interposed between the first and second substrates; and
a plurality of gate lines and data lines formed on the first substrate, thereby defining a plurality of pixel regions; each pixel region comprising:
a pixel electrode assembly comprising a pixel line and at least one pixel electrode, one of the at least one pixel electrode defining an acute angle junction region where said one of the at least one pixel electrode adjoins the pixel line;
a common electrode assembly spaced apart from the pixel electrode assembly, and comprising a common line at least one common electrode; and
a transistor positioned at the acute angle junction region.

2. The liquid crystal display as recited in claim 1, wherein the transistor is positioned on an intersection of the data line and the gate line.

3. The liquid crystal display as recited in claim 1, wherein the transistor is a thin film transistor.

4. The liquid crystal display as recited in claim 1, wherein the at least one pixel electrode is a generally zigzagged pixel electrode.

5. The liquid crystal display as recited in claim 1, wherein the at least one pixel electrode is a undulate pixel electrode.

6. The liquid crystal display as recited in claim 1, wherein the at least one pixel electrode is a wavy pixel electrode.

7. A panel, comprising:
a substrate defining a plurality of pixel regions; and
a plurality of gate lines and data lines formed on the substrate, thereby defining a plurality of pixel regions; each pixel region comprising:
a pixel electrode assembly comprising a pixel line and at least one pixel electrode, one of the at least one pixel electrode defining an acute angle junction region where said one of the at least one pixel electrode adjoins the pixel line; and
a plurality of transistors positioned at the acute angle junction regions.

8. The liquid crystal display as recited in claim 7, wherein the transistor is positioned on an intersection of the data line and the gate line.

9. The liquid crystal display as recited in claim 7, wherein each of the transistors is a thin film transistor.

10. The liquid crystal display as recited in claim 7, wherein the at least one pixel electrode is a generally zigzagged pixel electrode.

11. The liquid crystal display as recited in claim 7, wherein the at least one pixel electrode is a undulate pixel electrode.

12. The liquid crystal display as recited in claim 7, wherein the at least one pixel electrode is a wavy pixel electrode.

13. A liquid crystal display, comprising:
a first substrate;
a second substrate opposite to the first substrate;
a plurality of liquid crystal molecules interposed between the first and second substrates; and
a plurality of gate lines and data lines formed on the first substrate, thereby defining a plurality of pixel regions; each pixel region comprising:
a pixel electrode assembly comprising a pixel line and at least one pixel electrode, one of the at least one pixel electrode defining a lower light transmission region and a higher light transmission region at two sides thereof where said one of the at least one pixel electrode adjoins the pixel line;
a common electrode assembly spaced apart from the pixel electrode assembly, comprising a common line, at least one arcuate common electrode; and
a transistor positioned at the lower light transmission region.

14. The liquid crystal display as recited in claim 13, wherein the transistor is positioned on an intersection of the data line and the gate line.

15. The liquid crystal display as recited in claim 13, wherein the transistor is a thin film transistor.

16. The liquid crystal display as recited in claim 13, wherein the at least one pixel electrode is a generally zigzagged pixel electrode.

17. The liquid crystal display as recited in claim 13, wherein the at least one pixel electrode is a undulate pixel electrode.

18. The liquid crystal display as recited in claim 13, wherein the at least one pixel electrode is a wavy pixel electrode.
